(19) United States
(12) Patent Application Publication
(10) Pub. No.: US 2008/0168181 A1
(43) Pub. Date: Jul. 10, 2008

(54) Initiating Communication Sessions from a First Computer Network to a Second Computer Network

(75) Inventors: Winfried Antonius Henricus Berkvens, Eindhoven (NL); Mark Henricus Verberkt, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 10/597,993

(22) PCT Filed: Feb. 7, 2005
(86) PCT No.: PCT/IB2005/050478

§ 371 Date: Aug. 15, 2006

(30) Foreign Application Priority Data
Feb. 19, 2004 (EP) 0410648.7

(51) Int. Cl. H04L 29/06

(52) U.S. Cl. 709/245

(57) ABSTRACT

The invention relates to a method, an interface device and system of computational devices for enabling starting of sessions from a first to a second network and to a computer program product performing the method. A name and service query is received (68) in an interface from a first computational device communicating via the first network concerning a second device in the second network. The query includes a first address of the second network in a first addressing realm. A second address and a service port number of the second device in a second addressing realm is looked up (70), the first address and a session port number are bound to the second address and the service port number (76), and the query is answered with a message comprising the first address and session port number (78).

The present invention generally relates to the field of communication between computer networks and more particularly to the interface between two computer networks. The present invention furthermore relates to a method, interface device and system of computational devices for enabling starting of sessions from a first computational device communicating via a first network having a first addressing realm to a second computational device on a second network having a second addressing realm as well as to a computer program product for performing said method.

In the field of addressing in computer systems, there is normally a shortage of available public addresses to be used by different devices. This has led to many local networks having only one or a few public addresses used for the whole local system and then the local system will communicate with a global network via a gateway controlling these few addresses. Normally such a gateway will in this case be using a local addressing system for communicating with the devices in the local network.

In order to initiate sessions from such devices within a local network with other devices via a global network, the gateway is normally provided with a NAT (Network Address Translator) unit, which translates the local address to a global address for the communication with the other devices. A device within the local network can then start a session with a device outside the local network and the NAT unit would then set up an entry in the NAT table for such session, indicating how addresses are to be translated in order for the two devices to communicate with each other. There is however one problem with these kind of known NAT units, in that they do not allow communication sessions to be started from a device outside the local network, but only from inside the local network. There is a need for being able to start sessions from outside, for instance when doing peer-to-peer networking, where at least one side has to be able to accept incoming sessions.

The Internet Society describes one method of starting sessions from a global network to a device within a local network in RFC 2694 by P. Srisuresh, G. Tsirtsis, P. Akkiraju and A. Heffeman, September 1999. Here a gateway, which is an interface between the local network and the global network, has a number of addresses that can be used in the global network. The gateway also includes a NAT unit and a DNS_ALG (Domain Name System Application Level Gateway) unit and the local network also includes a DNS server. When a device on the global network wants to start a session, it sends a name query, which eventually reaches the gateway. The gateway forwards this query to the DNS server, which returns a local address of a local device associated with the queried name to the gateway. The gateway binds one of its global addresses to the local address and returns the global address as an answer to the query. The device on the global network can then start a session with this global address and the gateway immediately knows which device communication is intended for because of the binding. There are a few problems with this solution and that is that one global address is reserved for each device on the local network session. If there are parallel sessions to many devices on the local network, there have to be many global addresses available for the gateway, which is normally difficult due to a shortage of global addresses in present day systems. It is furthermore often expensive to have more than one global address associated with a local network, which leads to the number of addresses wanted being a limited minimum. If the local network only has one address, this one address will be tied up to one session and there is no possibility for more inbound sessions.

The above-described document also briefly mentions that a NAPT (Network Address and Port Translator) table can be provided in the gateway. This would however most likely be used in the traditional NAPT usage, i.e. in setting up sessions initiated from the local network. The document does not describe how sessions set up from the global network to the local network can use a NAPT for the address translation.

Another device that exists is a so-called DNS (Domain Name System) SRV (Service) device, which is described by the Internet Society in RFC2782, “DNS SRV RR”, by A. Gulbrandsen, P. Vixie and L. Esibov, February 2000. A DNS SRV receives queries regarding a name and a service of a device and returns an address and a port number as a result of the query. This document is however silent regarding the environment in which this device is to be used.

There is thus still a need for a way of allowing multiple parallel inbound sessions from a global network to multiple devices on a local network having a limited number of global addresses.

It is an object of the present invention to provide a mechanism by which more than one session can be started from devices via a first network having a first addressing realm to devices in a second network having a second addressing realm, which mechanism is transparent to the devices communicating via the first network, i.e. they do not have to have any real knowledge of how they communicate with devices in the second network, while at the same time only needing one address for the whole second network in the first addressing realm.

The invention is defined by the independent claims.

The dependent claims define advantageous embodiments.

Claims 2 and 10 are directed towards providing the device name and service name resolving for two queries, one regarding the device name and the other regarding the service name and responding to these queries with two messages.

Claims 3 and 11 are directed towards generating the response to the query in the second addressing realm and replacing the second address and service port number for an address and port number of the gateway.

Other dependent claims are directed towards providing a specific service port number in the query, which facilitates the forwarding of the query to the name and service resolving unit.

An embodiment of the present invention has the advantage of allowing several parallel sessions with different devices in the second network started from the first network even though only one address in the first addressing realm is used for the second network.

This does not mean that the gateway must have only one address in the first addressing realm, but it can have several such addresses. The present invention thus allows peer-to-peer networking, such that the first and second devices can both act as clients and servers and have both inbound and outbound sessions. Another advantage of the present invention is that it is based on an already existing protocol, the DNS SRV protocol, which makes the invention straightforward to implement.

The general idea behind an embodiment of the present invention is thus to bind a first address and a port number of a first addressing realm associated with an interface between the first addressing realm and a second addressing realm to a second address and a port number of a second device in the second addressing realm upon reception of a query from a first device. From the query a name and service look up of the second address and port number of the second device is made. A response to the query is then sent including the first address and a port number of the interface in the first addressing realm.

These and other aspects of the invention will be apparent from and elucidated with reference to the embodiments described hereinafter.

The present invention will now be explained in more detail in relation to the enclosed drawings, where

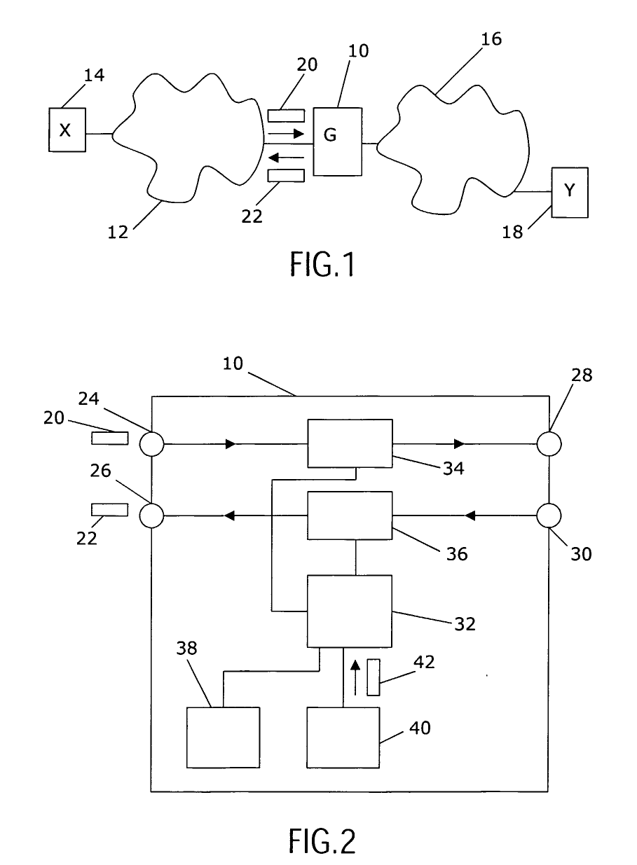

FIG. 1 shows a schematic drawing of a first network connected to a second network via a gateway according to the invention,

FIG. 2 shows a block schematic of the gateway according to the present invention,

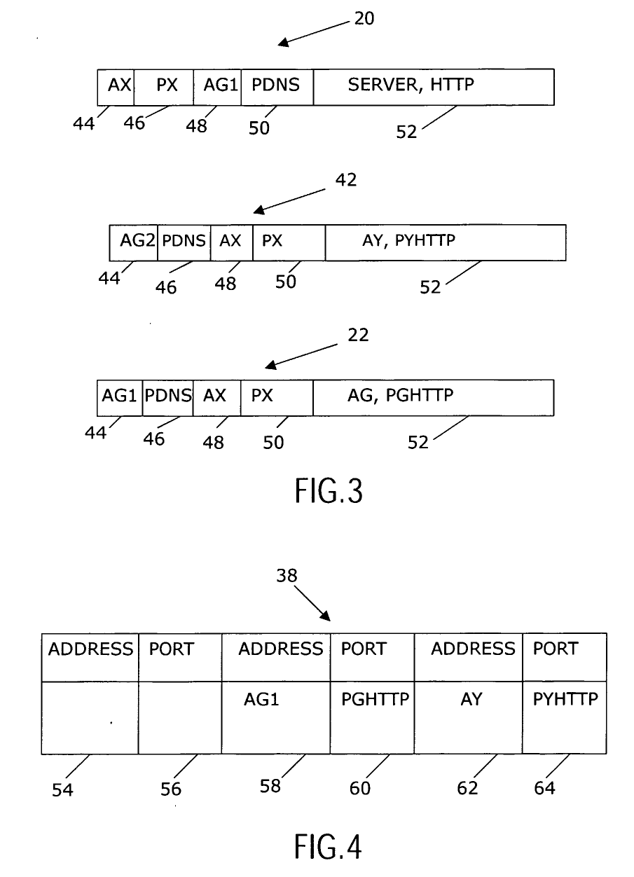

FIG. 3 shows a number of messages sent between the devices and units in FIGS. 1 and 2 for initiating a session,

FIG. 4 shows a binding for the session made in a NAPT table provided in the gateway,

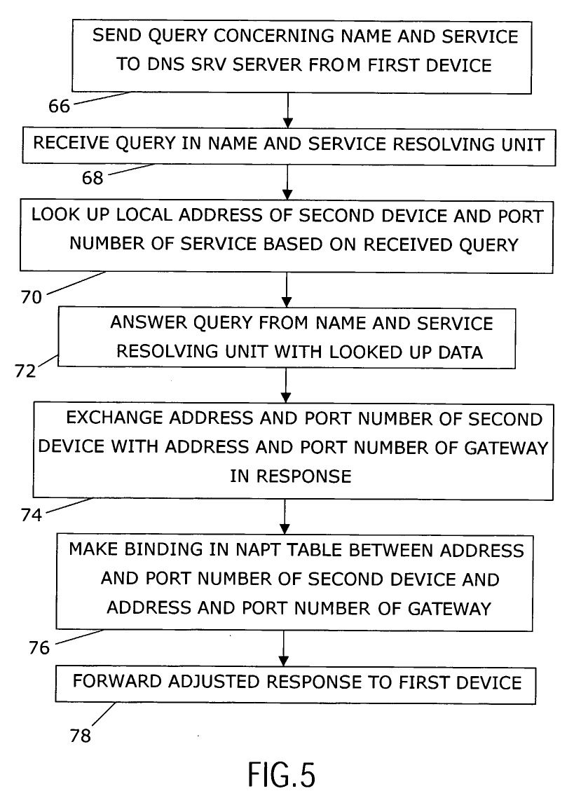

FIG. 5 shows a flow chart of a method of initiating a session from the first network to the second network according to the invention,

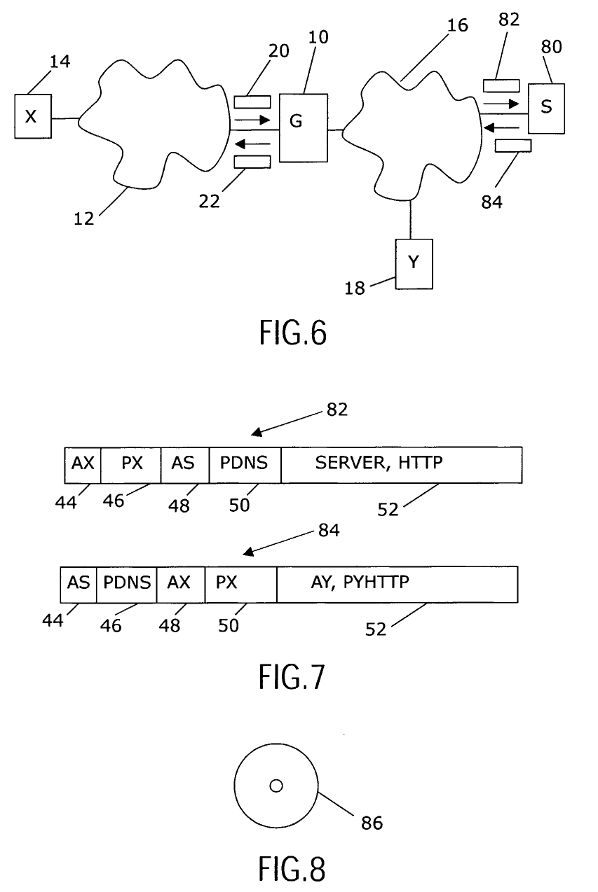

FIG. 6 shows a schematic drawing of an alternative embodiment of the second network including a name and service resolving server,

FIG. 7 shows messages sent in the second network to and from the name and service resolving server, and

FIG. 8 schematically shows a computer readable medium on which is stored program code for performing the method according to the invention.

FIG. 1 shows a schematic drawing of an embodiment of the invention and it's environment. FIG. 1 shows an interface device 10 according to the invention connected to a first network 12, which in this case is the Internet. A first computational device 14 is connected to the first network 12. The interface device 10, which in the preferred embodiment is a gateway is also connected to a second network 16, which network includes a second computational device 18. The first network 12 has a first addressing realm and the second network has a second addressing realm. The first addressing realm is here an IP-addressing realm, for instance IPv4, and used globally, while the second addressing realm is a local addressing realm used inside the second network 16. This second addressing realm is normally also using IP-addressing. The second network 16 is in the preferred embodiment a private home network. It should however be realized that the invention is not limited to private home networks, but can also be used for example in a corporate network. The first computational device 14 is also denoted X, the second computational device 18 is denoted Y and the gateway 10 is denoted G. The different devices thus have different addresses in the different realms. The first device 14 has an address AX in the first addressing realm, the gateway 10 has a first address AG1 in the first addressing realm, while the second device 18 has a second address AY in the second addressing realm. It should be noted that the gateway 10 also has an address AG2 in the second addressing realm. The second device 18 can be a regular computer, but is not limited to this. It can be another computational device as well such as an Internet Radio server, a printer, a scanner or any other type of equipment, which can be connected in computer networks using an address that provides a service, which can be accessed by other devices. It should also be realized that there might be more devices in the second network 16. The first device 14 might for instance similarly be any suitable device, which can be connected to the Internet 12 and that has client capabilities, i.e. has functionality for obtaining access to the service of the second device 18. It should also be realized that the first device 14 might be a device on a private or local network communicating with the Internet via a gateway. It is here shown as a device connected directly to the Internet in order to better explain the invention. FIG. 1 also shows a query 20 sent from the first device 14 to the second network 16 as well as a response 22 to that query.

A simplified embodiment of the gateway 10 according to the invention is shown in a block schematic in FIG. 2. The gateway 10 has a first input 24 connected to the Internet for reception of data packets and a first output 26 also connected to the Internet for sending of data packets. The gateway also has a second output 28 connected to the second network for sending of data packets and a second input 30 also connected to the second network for reception of data packets. A first register 34 is connected between the first input 24 and the second output 28, while a second register 36 is connected between the second input 30 and the first output 26. The directions the data packets are traveling are indicated with arrows. The first and second registers 34 and 36 are both connected to a control unit 32, which control unit 32 comprises a DNS SRV_ALG (Application Level Gateway) unit and is connected to a NAPT (Network Address and Port Translator) table 38 and to a name and service resolving unit 40. The NAPT 38 is used for translating of local addresses and local port numbers to global addresses and global port numbers, i.e. from addresses and port numbers in the second addressing realm into addresses and port number in the first addressing realm and vice versa. The name and service resolving unit 40 is a server with DNS SRV (Domain Name System Service) capabilities, i.e. it maps a domain name and service name to an address and a port number and here to an address and a port number in the second addressing realm. FIG. 2 also shows a message 42 that is generated as a response to the query 20, which response is then modified into message 22 leaving the second network 16.

FIG. 3 shows the messages 20, 22 and 42 from FIGS. 1 and 2 in some more detail. The messages each have a source address field 44, a source port number field 46, a destination address field 48, a destination port number field 50 and a payload 52, where fields 44-50 make up the header of the message. FIG. 4 shows entries made in the NAPT table 38 of FIG. 2 based on these messages. After a session has been initiated but before any packets have been received. Each row of the table is dedicated to an ongoing session or a session that has just been initiated. For simplicity only one row or session is shown here, although it should be realized that there can be several rows for sessions between different devices and actually several rows for different sessions between the same two devices or several sessions to the same device on the second network from several devices on the first network or several sessions from the same device on the first network to several devices on the second network. A first column 54 is used for the addresses of devices in the first network having or initiating a session, which is here left blank. A second column 56 is used for port numbers associated with the address of a device on the first network, which column is also left blank. These are blank because no session has yet been started for a device on the first network. A third column 58 is intended for addresses of the second network in the first addressing realm, which here has the first address AG1 of the gateway. A fourth column 60 is intended for the port numbers of the second network in the first addressing realm and is here a port number PGHTTP. A fifth column 62 is intended for the addresses of the second network that exist in the second addressing realm of devices involved or to be involved in sessions, which column here shows the second address AY of the second device, while a sixth column 64 is intended for port numbers used in relation to the addresses on the second network, which column here shows a port number PYHTTP. FIG. 5 shows a flow chart of a method according to the invention.

Now a first part of the invention will be described with reference being made to FIGS. 1, 2, 3, 4 and 5.

The first device 14 sends a query 20 to the name and service resolving unit 40 via gateway 10 in order to get an address for communicating with the second device 18, step 66. This query can either be recursive or non-recursive. This query, which is shown in the upper part of FIG. 3 includes a source address AX and a source port number PX in the fields 44, 46 and a destination address AG1 and destination port number PDNS in fields 48, 50. The address and port number could have been found by consulting DNS and/or DNS SRV servers within the first network that provide the address AG1 and port number PDNS. The address AG1 is the address of the second network or the gateway 10 in the first addressing realm, while the port number PDNS is a special port number used for name and service queries. The query 20 furthermore comprises payload 52 comprising a device name “server” that is queried as well as service name “http” that is also queried. This device name is the domain name associated with the second device 18, while the service name is the name of a service offered by the second device. This query could have been preceded by a number of previous queries sent to other DNS and/or DNS SRV servers in the first network 12. For each such DNS and/or SRV server contacted with the query, that server has indicated to the first device 14 a DNS and/or DNS SRV server at a lower hierarchical level. In this way the first device 14 could have queried a number of DNS and/or DNS SRV servers until it directly contacts the gateway 10, which includes the name and service resolving unit 40 mapping the name of the second device 18 to an address. As an alternative the query could be directly forwarded by the first DNS and/or DNS SRV server contacted to a next DNS and/or DNS SRV server until the query eventually reaches the name and service resolving unit 40.

The gateway 10 then receives the query 20, step 68, on the first input 24 and forwards it to the first register 34. Then control unit 32 analyses the address AG1 and port number PDNS and forwards the query to the name and service resolving unit 40 in dependence of this address and port number. The port number PDNS is a service resolving port number that is dedicated to these types of queries. The name and service resolving unit 40 makes an address and port number look up in the second addressing realm based on the name query, step 70, and in this way finds an address AY of the second device 18 in the second addressing realm and a port number PYHTTP of the second device 18 associated with the service.

The name and service resolving unit 40 then generates and returns a response 42 to the query 20 to the control unit 32, which response is shown in the middle of FIG. 3. The response 42 to the query here includes the second address AY and the service port number PYHTTP in the payload 52. Since the name and service resolving unit 40 is provided in the gateway 10, the source address and source port numbers are set as AG2, the address of the gateway 10 on the second network 16, and PDNS in fields 44 and 46. The destination address and port number are also set as AX and PX in fields 48, 50. It should be realized that this response data need not be provided in the form of a message, but can be provided to the control unit as “raw” data, whereupon the control unit creates the actual response message. The query is thus answered from the name and service resolving unit 40 with the looked up data, i.e. address AY and port number PYHTTP, step 72. The control unit 32 then replaces the second address AY with the first address AG1 associated with the gateway and port number PYHTTP with a port number PGHTTP in the payload 52 of the response as well as replaces the source address AG2 with the source address AG1, the first address of the gateway 10, and puts the thus changed reply or message 22 in the second register 36, step 74. This port number PGHTTP is a session port number that is selected for the session. The message 22 is shown in the bottom part of FIG. 3. The control unit 32 also makes a binding between the address AY and port number PYHTTP of the second device 18 and the address AG1 and port number PGHTTP of the gateway 10 in the NAPT, step 76. Thus for a session the third column 58 of the NAPT 38 receives the address AG1, the fourth column 60 receives a session port number PGHTTP, the fifth column 62 receives the address AY and the sixth column 64 receives the service port number PYHTTP.

The control unit 32 then forwards the adjusted response message 22 to the first device 14 via the first output 26, step 78. The first device 14 will now receive a response on the name and service query, which points out the gateway 10 instead of second device 18 as being associated with the name of device 18 and a port number of the gateway as corresponding to the service. The first device can now start a session using the first address AG1 as destination address and port number PGHTTP as port number. The first device 14 thus sends one query to the gateway 10 and can immediately start the session upon receipt of the reply, which reply can be provided in one single data packet. The first device 14 thus does not need to communicate with the gateway 10 more than once before starting the session. However the gateway will know that data packets are intended for the second device because of the settings made in the NAPT table 38. When a first packet in the session then is received in the gateway from the first device 14, an actual binding takes place in that the used address and port numbers of the first device are set in the first 54 and second 56 columns of the NAPT table 38. As an alternative the first and second columns 54 and 56 are not filled with data at all. It is furthermore possible that the NAPT 38 does not have these columns at all. The message, which then has destination address AG1 and port number PGHTTP gets translated in the control unit 32 by looking in the NAPT table 38 to address AY and port number PYHTTP in the header and forwarded to the second device 18. With the table 38 set this way packets can be exchanged between the first and second device. As mentioned earlier the first device can also be provided in a local network having a third addressing realm. In this case the address and port number of the first device are also translated into a corresponding gateway address and port number in a similar fashion. Then the address and port number of the first device that is provided in the messages in FIG. 3, would be replaced by an address and port number of the gateway of the third addressing realm.

In the preferred embodiment the name and service resolving unit is part of the gateway. In an alternative embodiment, the name and service resolving unit can be a separate entity or server on the second network with which the gateway would communicate in order to resolve the name and service. This embodiment is schematically shown in FIG. 6, where the name and service resolving server has received reference number 80. A translated version 82 of the query 20 and a generated response to the query 84 are shown in FIG. 7, where these messages 82 and 84 have the same format as the previously mentioned messages. Here the gateway 10 performs an address and port number translation of the destination address AG1 and port number PDNS in the inbound query 20 to query 82 of the second network having a third address AS and port number PDNS associated with the name and service resolving server 80, and sends the translated query 82 to the name and service resolving unit 80. The name and service resolving unit 80 makes a response 84, where the source address is the local third address AS in the second addressing realm of the unit 80 and a port number PDNS also in this realm. The gateway 10 then performs an address and port number translation of the source address and port number in the response message and forwards the adjusted message 22 to the first device.

Another possible variation is that the name and service resolving unit can be distributed in the various end devices of the second network.

The different units in the gateway are normally provided in the form of one or more processors together with suitable program memory containing appropriate program code for performing the method according to the invention. The table is also normally provided in the form of a memory. The software or program code for performing this can also be provided on a computer program product in the form of a computer readable medium, which will perform the method according to the invention when loaded into the gateway. One such medium in the form of a CD Rom disc 86 is depicted in FIG. 8, although there are many different mediums possible such as diskettes. The program code can also be downloaded remotely from a server outside the second network.

It should also be understood that the gateway described could include several more registers in the form of different input, output and buffer registers. The numbers have intentionally been kept low for getting a better understanding of the invention.

For every new connection that is set up a new name and service resolving process need to be executed. Therefore the first device should not store the address and port number of the destination device and service.

The present invention thus provides a possibility to initiate sessions from outside the second network, while at the same time only needing one address in the first addressing realm for the second network and still allowing several inbound sessions. This does not mean that the gateway must have only one address in the first addressing realm, but it can have several such addresses. The present invention thus allows peer-to-peer networking, such that the first and second devices can both act as clients and servers and have both inbound and outbound sessions. Another advantage of the present invention is that it is based on an already existing protocol, the DNS SRV protocol, which makes the invention straightforward to implement. Yet another advantage is that the binding in the NAPT table can be performed in one stage.

The port numbers used in the name and service resolving unit are specific port numbers that specify a certain service, which has here been exemplified by HTTP services, naturally different port numbers then specify different services. The port numbers in the NAPT table associated with the first address of the gateway that are selected for the binding to the second address and service port number of the second device are normally the next available port number of a number of free port numbers provided in the gateway. This port number is then only used for identifying device and service on the second network, which however is not known by the first device. There are however some reserved port numbers in the gateway. One such port number is a service resolving port number PDNS, which indicates that a received packet is a name and service query. This port number has been denoted as PDNS before and after address translation in the gateway. It should however be realized that this port number might be translated as well in the gateway before being sent on to the name and service resolving unit both when it is provided inside the gateway and in the second network. These packets are automatically forwarded to the name and service resolving unit based on the specific port number.

The present invention thus provides a system, an interface device, a method and a computer program product, which facilitates initiation of sessions from a first network to a second network.

There are a number of possible variations to the invention, which can be made in addition to those already mentioned. The query might be divided into two queries, one for the address and one for the service name. In this case there would also be two responses, one for each query. The invention is not limited to IP-addressing, but other types of addressing are also possible. The first input and output of the gateway can also be combined into a single communication interface. The networks do not need to be fixed networks, but can also for instance be wireless networks.

1. Method of enabling starting of sessions from a first computational device (14) communicating via a first network (12) having a first addressing realm to a second computational device (18) on a second network (16) having a second addressing realm, comprising the steps of:
receiving at least one query (20) concerning the second device including at least a device name (server) and a service name (http) associated with the second device, which query has a first destination address (AG1) of the first addressing realm associated with the second network, (step 68),
looking up a second address (AY) as well as a service port number (PYHTTP) associated with a service of the second device in the second addressing realm based on the device name and service name, (step 70),
binding the first address (AG1) and a session port number (PGHTTP) of the first addressing realm to the second address (AY) and the service port number (PYHTTP) of the second device (18) in the second addressing realm, (step 76), and
answering the query (20) of the first device (14) with at least one message (22) leaving the second network comprising the first address and the session port number of the first addressing realm, such that a session can be started from the first device to the second device where the first address and session port number of the first addressing realm and the second address and the service port number of the second addressing realm are exchanged with each other in the headers of packets of the session when passing between the two networks.

2. Method according to claim 1, wherein the step of receiving comprises receiving two queries, one including the device name and one including the service name and the step of answering the query comprises answering with two messages, one including the first address and the other including the session port number.

3. Method according to claim 1, wherein the step of answering the query comprises the steps of generating said message (42; 82) including the second address (AY) and service port number (PYHTTP) of the second addressing realm as a response to the query, (step 72), replacing the second address and service port number of the second addressing realm in the response message for the first address (AG1) and session port number of the first addressing realm, (step 74), and sending the message (22) with the replaced information to the first device from the second addressing realm, (step 78).

4. Method according to claim 1, wherein the query further comprises a specified service resolving port number (PDNS).

5. Method according to claim 4, further comprising the step of translating the first address and the service resolving port number to a third address (AS) and service resolving port number (PDNS) of the second addressing realm associated with a name and service resolving server (80) of the second addressing realm, forwarding the query (82) with translated address and port number to the name and service resolving server, generating the response (84) to the query in the name and service resolving server as a message with the third address and service resolving port number as source address, and translating the third address and service resolving port number of the second addressing realm to the first address and service resolving port number of the first addressing realm before the response leaves the second network.

6. Method according to claim 1, further including the step of receiving a first data packet of the session from the first device at the interface having the first address and session port number of the first addressing realm as destination address, translating the first address and session port number of the first addressing realm to the second address and service port number of the second addressing realm and forwarding the packet to the second device in the second addressing realm using this latter address and service port number.

7. Method according to claim 1, wherein the session port number of the first addressing realm is different than the service port number of the second addressing realm.

8. Interface device (10) for connection between a first network (12) having a first addressing realm and a second network (16) having a second addressing realm enabling starting of sessions from a first computational device (14) communicating with the interface device via the first network to a second computational device (18) in the second network, comprising:
a first input (24) to be connected to the first network for receiving at least one query (20) concerning the second device, which query includes at least a device name (server) and a service name (http) associated with the second device and has a first destination address (AG1) of the first addressing realm associated with the second network,
a first output (22) for connection to the first network,
a name and service resolving unit (40) arranged to look up a second address (AY) as well as a service port number (PHTTP) associated with a service of the second device in the second addressing realm based on the device name and the service name,
an address and port translation table (38), and
a control unit (32) arranged to:
bind the received first address (AG1) and a session port number of the first addressing realm (PGHTTP) to the second address (AY) and service port number (PYHTTP) belonging the second device in the second addressing realm in the address and port translation table, and
provide a message (22) leaving the second network as at least one answer to the query comprising the first address and the session port number of the first addressing realm to the first device, such that a session can be started from the first device to the second device where the first address and session port number of the first addressing realm and the second address and service port number of the second addressing realm are exchanged with each other in the headers of packets of the session when passing between the two networks.

9. System of computational devices for connection to a first network (12) having a first addressing realm, via which first network a first computational device (14) can communicate with the system and comprising a second network (16) having a second addressing realm, said second network comprising:
a second computational device (18), and
an interface device (10) provided between the first and second networks comprising:
a first input (24) to be connected to the first network for receiving a query (20) concerning the second device, which query includes at least a device name (server) and a service name (http) associated with the second device and has a first destination address (AG1) of the first addressing realm associated with the second network,
a first output (26) for connection to the first network,
an address and port translation table (38), and
a control unit (32) arranged to:
bind the first address (AG1) and a session port number (PGHTTP) of the first addressing realm to a second address (PY) and a service port number (PYHTTP) belonging to the second device in the second addressing realm in the address and port translation table, and
provide a message (22) leaving the second network as an answer to the query of the first device comprising the first address and the session port number of the first addressing realm,
wherein the second network further comprises a name and service resolving unit (40; 80) arranged to look up the second address (AY) as well as the service port number (PYHTTP) associated with a service of the second device in the second addressing realm based on the device name and the service name, such that a session can be started from the first device to the second device where the first address and session port number of the first addressing realm and the second address and the service port number of the second addressing realm are exchanged for each other in the headers of packets of the session when passing between the two networks.

10. System of devices according to claim 9, wherein the first input is arranged to receive two queries, one including the device name and one including the service name and the control unit is arranged to answer the query with two messages, one including the first address and the other including the session port number.

11. System of devices according to claim 9, wherein the name and service resolving unit when answering the query is arranged to generate said message (42; 84) including the second address and service port number of the second addressing realm as a response to the query and the control unit of the interface device is arranged to replace the second address and service port number of the second addressing realm in the response message with the first address and session port number of the first addressing realm and send the message with the replaced information to the first device from the second addressing realm.

12. System of computational devices according to claim 9, wherein the name and service resolving unit (40) is provided in the interface device.

13. System of devices according to claim 9, wherein the name and service resolving unit (80) is provided in a name and service resolving server in the second network.

14. System of devices according to claim 13, wherein the query further comprises a service resolving port number (PDNS) and the control unit (32) is further arranged to translate the first address and the service resolving port number to a third address (AS) and service resolving port number (PDNS) of the second addressing realm associated with the name and service resolving server of the second addressing realm, forward the query with translated address and service resolving port number (82) to the name and service resolving server, the name and service resolving server is further arranged to generate the response (84) to the query as a message with the third address and service resolving port number as source address, and the control unit is finally arranged to translate the third address and service resolving port number of the second addressing realm to the first address and service resolving port number of the first addressing realm before the response leaves the second network.

15. System of devices according to claim 9, wherein the first input of the interface device is further arranged to receive a first data packet of the session from the first device having the first address (AG1) and session port number (PGHTTP) of the first addressing realm as destination address, wherein the address and port translating table (38) is arranged to translate the first address and session port number of the first addressing realm to the second address and service port number of the second addressing realm and the control unit is arranged to forward the packet to the second device in the second addressing realm using this latter address and service port number.

16. System of devices according to claim 9, wherein the session port number (PGHTTP) of the first addressing realm is different than the service port number (PYHTTP) of the second addressing realm.

17. Computer program product (86) to be used on an interface device (10) between a first network (12) having a first addressing realm and a second network (16) having a second addressing realm, wherein a first computational device (14) can communicate with the interface device via the first network and the second network comprises a second computational device (18), said computer program product having:
computer program code, to make the interface device execute, when said program code is loaded in the interface device:
upon reception of at least one query (20) from the first computational device concerning the second computational device, which query includes a device name (server) and a service name (http) associated with the second device and has a first destination address (AG1) of the first addressing realm associated with the second network,
looking up a second address (AY) as well as a service port number (PYHTTP) associated with a service of the second device in the second addressing realm based on at least the device name and service name,
binding the first address (AG1) and a session port number (PGHTTP) of the first addressing realm to the second address (AY) and service port number (PYHTTP) of the second device in the second addressing realm, and
answering the query with at least one message (22) leaving the second network comprising the first address and the session port number of the first addressing realm to the first device, such that a session can be started from the first device to the second device, where the first address and session port number of the first addressing realm and the second address and the service port number of the second addressing realm are exchanged with each other in the headers of packets of the session when passing between the two networks.
